(19) United States
(12) Patent Application Publication
(10) Pub. No.: US 2011/0086543 A1
(43) Pub. Date: Apr. 14, 2011

(54) F-Style Coaxial Connectors Having Internally Threaded Nuts that Exhibit Increased Drag and Mechanical Resistance

(76) Inventors: Mark E. Alrutz, Hickory, NC (US); Neil Phillips, Dove Canyon, CA (US)

(21) Appl. No.: 12/576,305

(22) Filed: Oct. 9, 2009

(51) Int. Cl. H01R 9/05

(52) U.S. Cl. 439/578

(57) ABSTRACT

Coaxial connectors include a connector body and an inner contact post mounted therein. These connectors further include a compression element that is configured to impart a generally circumferential compressive force to secure one or more elements of a coaxial cable between the connector body and the inner contact post, and an internally threaded rotatable nut that is configured for attachment to the connector body. In some embodiments, the nut has a first set of threads and a second set of threads that is immediately adjacent to the first set of threads, where the threads of the second set of threads are configured to provide increased drag and mechanical resistance as compared to threads of the first set of threads when the rotatable nut is threaded onto a female coaxial cable port. In other embodiments, an internal diameter of the threaded portion of the nut varies along the axial direction. In still other embodiments, a bushing is mounted within the threaded region of the nut.

### FIELD OF THE INVENTION

The present invention relates generally to communications connectors and, more particularly, to connectors for coaxial cables.

### BACKGROUND

Coaxial cables are a specific type of electrical cable that may be used to carry information signals such as television or data signals. Coaxial cables are widely used in cable television networks and to provide broadband Internet connectivity. FIGS. 1 and 2 are, respectively, a transverse cross-sectional view and a longitudinal cross-sectional view of a conventional coaxial cable 10 (FIG. 2 is taken along the cross section 2-2 shown in FIG. 1). As shown in FIGS. 1 and 2, the coaxial cable 10 has a central conductor 12 that is surrounded by a dielectric 14. A tape 16 is preferentially bonded to the dielectric 14. The central conductor 12, dielectric 14 and tape 16 comprise the core 18 of the cable. Electrical shielding wires 20 and, optionally, electrical shielding tape(s) 22 surround the cable core 18. Finally, a cable jacket 24 surrounds the electrical shielding wires 20 and electrical shielding tape(s) 22. As shown in FIG. 2, the dielectric 14, tape 16, electrical shielding wires 20, electrical shielding tape 22 and cable jacket 24 may be cut, and the electrical shielding wires 20, electrical shielding tape 22 and cable jacket 24 may be folded back, in order to prepare the coaxial cable 10 for attachment to certain types of coaxial connectors.

Coaxial connectors are a known type of connector that may be used to connect two coaxial cables 10 or to connect a coaxial cable 10 to a device (e.g., a television, a cable modem, etc.) having a coaxial cable interface. Coaxial “F” connectors (herein “F-style coaxial connectors”) are a specific type of coaxial connector that may be used to terminate a coaxial cable. As is known to those of skill in the art, F-style coaxial connectors are a male connector that mate with female coaxial cable ports.

FIG. 3 is a perspective view of a conventional F-style coaxial connector 30. FIG. 4 is a side cross-sectional view of the prior art coaxial “F” connector of FIG. 3. FIG. 5 illustrates the connector 30 of FIG. 3 after it has been attached to an end of a coaxial cable 10. As shown in FIGS. 3 and 4, the connector 30 includes a tubular connector body 32, a compression sleeve 34, an inner contact post 36 and an internally threaded nut 38. As shown in FIG. 5, the coaxial cable 10 is inserted axially into the inside diameter of the tubular connector body 32 and the compression sleeve 34. Referring to FIG. 4, the core 18 of the coaxial cable 10 inserts axially into an inside diameter of the inner contact post 36, while the electrical shielding wires/tape 20/22 and the cable jacket 24 circumferentially surround the outer surface of the inner contact post 36 (the cable 10 is not shown in FIG. 4). The outside surface of the inner contact post 36 may include one or more serrations, teeth, lips or other retention structures 37 (see FIG. 4). Once the cable 10 is inserted into the connector 30 as described above, a compression tool may be used to axially insert the compression sleeve 34 further into the tubular connector body 32 into the position shown in FIG. 5. The compression sleeve 34 directly decreases the radial gap spacing between the connector body 32 and the inner contact post 36 so as to radially impart a 360-degree circumferential compression force on the electrical shielding wires/tape 20/22 and the cable jacket 24 that circumferentially surround the outer surface of inner contact post 36. This compression, in conjunction with the retention structures 37 on the outside surface of the inner contact post 36, applies a retention force to the coaxial cable 10 that holds the cable 10 within the connector 30. As shown in FIG. 5, the central conductor 12 of the coaxial cable 10 extends into the internal cavity of the nut 38 to serve as the male protrusion of the connector 30.

As is known to those of skill in the art, F-style coaxial connectors are used to mechanically and electrically attach a coaxial cable such as cable 10 to a female coaxial cable port such as, for example, a standard coaxial cable wall outlet or a port on an electronic device such as a cable-ready television set. FIG. 6 is a perspective view of a conventional female coaxial cable port 40. As shown in FIG. 6, the female coaxial cable port 40 may comprise a cylindrical port that has an at least partially threaded external surface 42. The distal end of the cylinder includes an aperture 44 that receives the central conductor 12 of a mating F-style coaxial connector 30. The rotatable nut 38 of a mating connector 30 is inserted over, and threaded onto, the female coaxial cable port 40 so that the central conductor 12 of the coaxial cable 10 that is attached to the connector 30 is received within the aperture 44, thereby mechanically and electrically connecting coaxial cable 10 to the female coaxial cable port 40.

### SUMMARY

Pursuant to embodiments of the present invention, coaxial connectors are provided that include a connector body, an inner contact post that is at least partly within the connector body, and a compression element that is configured to impart a generally circumferential compressive force to secure one or more elements of a coaxial cable between the connector body and the inner contact post when the compression element is in a seated position. These connectors further include an internally threaded rotatable nut having a first set of threads and a second set of threads that is immediately adjacent to the first set of threads. The threads of the second set of threads are configured to provide increased drag and mechanical resistance as compared to threads of the first set of threads when the rotatable nut is threaded onto a female coaxial cable port. In some embodiment of these coaxial connectors, the second set of threads may include at least some of the four threads that are located closest to the inner contact post.

In some embodiments, the second set of threads may comprise tipped threads that have a thread angle that is offset from 90 degrees such as, for example, a thread angle that is offset from 90 degrees by between about 2 degrees and about 10 degrees. In other embodiments, the second set of threads may be tipped threads in which the major diameter and/or the minor diameter of the threads are decreased relative to the threads of the first set of threads so as to provide increased drag and mechanical resistance when the rotatable nut is threaded onto a female coaxial cable port.

In other embodiments, the second set of threads may be pipe threads. In still other embodiments, the second set of threads may be threads that include at least one defect such as, for example, a defect that is formed by applying an external force to the outside surface of the nut opposite the internal threads that forms a dimple in the outside surface of the nut. In the above-described embodiments, the nut may be formed of a material including bronze, and the seal that is created when the nut is threaded onto the female coaxial cable port may be a reversible seal that can be reversed via hand rotation of the nut.

Pursuant to further embodiments of the present invention, coaxial connectors are provided that include a connector body, an inner contact post that is at least partly within the connector body, and a compression element that is configured to impart a generally circumferential compressive force to secure one or more elements of a coaxial cable between the connector body and the inner contact post when the compression element is in a seated position. These connectors further include an internally threaded rotatable nut that is attached to the connector body, where the internal diameter of the threaded portion of the nut varies along the axial direction.

In some embodiments, the internal diameter is only varied over a subset of the threaded portion of the nut. For example, the internal diameter may be varied with respect to only (or at least) some of the four threads of the nut that are located closest to the contact post. The internal diameter may vary, for example, by between about 1% and about 3%.

Pursuant to still further embodiments of the present invention, coaxial connectors are provided that include a connector body, an inner contact post that is at least partly within the connector body, and a compression element that is configured to impart a generally circumferential compressive force to secure one or more elements of a coaxial cable between the connector body and the inner contact post when the compression element is in a seated position. These connectors further include an internally threaded rotatable nut that has a threaded region that includes a plurality of internal threads and a bushing that is mounted within the threaded region of the nut.

In some embodiments, the bushing may be located between a first subset of the plurality of internal threads and a second subset of the plurality of internal threads. The bushing may comprise, for example, a nylon or plastic annular bushing or a nylon or plastic plug that extends less than 90 degrees around the internal diameter of the nut. The bushing may be positioned such that when the nut is threaded onto a female coaxial cable port, a leading thread of the female coaxial cable port that is closest to a distal end of the female coaxial cable port will come into contact with the bushing within one to three full rotations of the nut before the distal end of the female coaxial cable port contacts the connector body. In some embodiments, no more than four threads are interposed between a first surface of the bushing that is closest to the contact post and an end of the nut that is closest to the contact post.

### BRIEF DESCRIPTION OF THE DRAWINGS

FIG. 1 is a transverse cross-sectional diagram of a conventional coaxial cable.

FIG. 2 is a longitudinal cross-sectional diagram of the conventional coaxial cable of FIG. 1.

FIG. 3 is a perspective view of a prior art F-style coaxial connector that has a compression style back fitting with the compression sleeve in a unseated position.

FIG. 4 is a side cross-sectional view of the prior art F-style coaxial connector of FIG. 3.

FIG. 5 is a perspective view of the prior art F-style coaxial connector of FIG. 3 mounted on a coaxial cable.

FIG. 6 is a perspective view of a conventional female coaxial cable port.

FIG. 7 is a perspective view of a F-style coaxial connector according to certain embodiments of the present invention.

FIG. 8 is an exploded perspective view of the F-style coaxial connector of FIG. 7 with certain components thereof shown in a cutaway view.

FIG. 9 is a side view of the connector of FIG. 7 in assembled form.

FIG. 10 is a side view of the connector of FIG. 7 with the compression sleeve partially removed.

FIG. 11 is a side view of the connector of FIG. 7 fully disassembled.

FIG. 12 is a perspective view of an internally threaded nut for an F-style coaxial connector that includes tipped threads according to certain embodiments of the present invention.

FIG. 13 is a cross-sectional view of the nut of FIG. 12 taken along the line 13-13 in FIG. 12.

FIG. 14 is a schematic diagram showing how tipped threads having a thread angle that varies from 90 degrees may be formed.

FIG. 15 is an enlarged cross-sectional view of the threads of a nut according to further embodiments of the present invention that has tipped threads in which the minor diameter has been decreased.

FIG. 16 is a perspective view of a nut for an F-style coaxial connector according to further embodiments of the present invention that includes pipe threads.

FIG. 17 is a cross-sectional view of the nut of FIG. 16 taken along the line 17-17 in FIG. 16.

FIG. 18 is an enlarged cross-sectional view of a small portion of the threads of the nut of FIGS. 16-17 after the nut has been mated with a female coaxial connector port.

FIG. 19 is a side cutaway view of a nut for an F-style coaxial connector according to still further embodiments of the present invention that includes at least one bushing.

FIG. 20 is a side cross-sectional view of an F-style coaxial connector according to additional embodiments of the present invention that includes a different bushing.

FIG. 21 is a perspective view of a nut for an F-style coaxial connector according to further embodiments of the present invention that has an internal diameter that is cut with a slight chamfer.

FIG. 22 is a cross-sectional view of the nut of FIG. 21 taken along the line 22-22 in FIG. 21.

FIG. 23 is a perspective view of a dimpled nut for an F-style coaxial connector according to further embodiments of the present invention.

FIG. 24 is a cross-sectional view of the nut of FIG. 23 taken along the line 24-24 in FIG. 23.

FIG. 25 is a cross-sectional view of another type of F-style coaxial connector that may include nuts according to embodiments of the present invention.

FIGS. 26-27 are an exploded perspective view and a cross-sectional view, respectively, of yet another type of F-style coaxial connector that may include nuts according to embodiments of the present invention.

FIG. 28 is a cross-sectional diagram of a portion of a nut that is mated with a bolt that illustrates the thread profiles for a Unified Thread Standard compliant nut and the bolt.

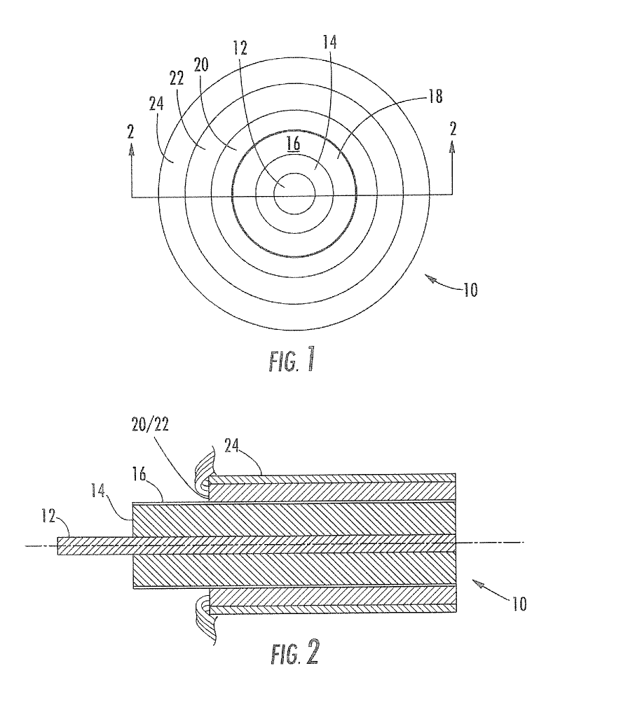

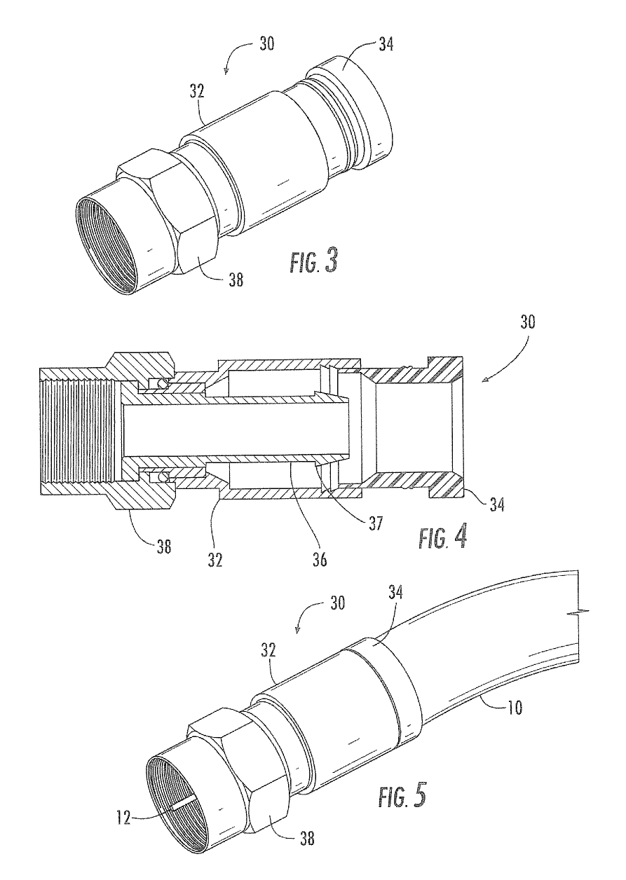

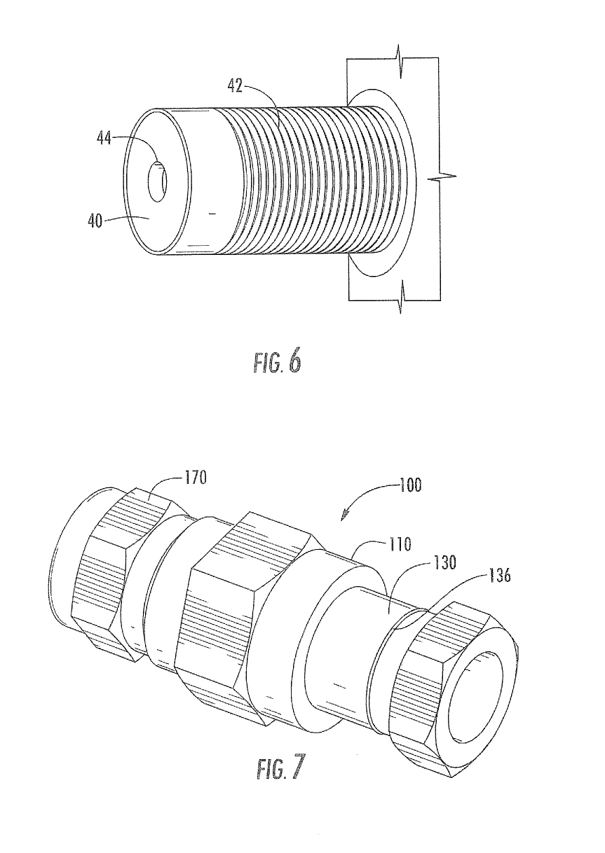

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the size and/or relative positions of lines and elements may be exaggerated for clarity. It will also be understood that when an element is referred to as being “coupled” to another element, it can be coupled directly to the other element, or intervening elements may also be present. In contrast, when an element is referred to as being “directly coupled” to another element, there are no intervening elements present. Likewise, it will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “front”, “rear” and the like are used herein for the purpose of explanation only.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

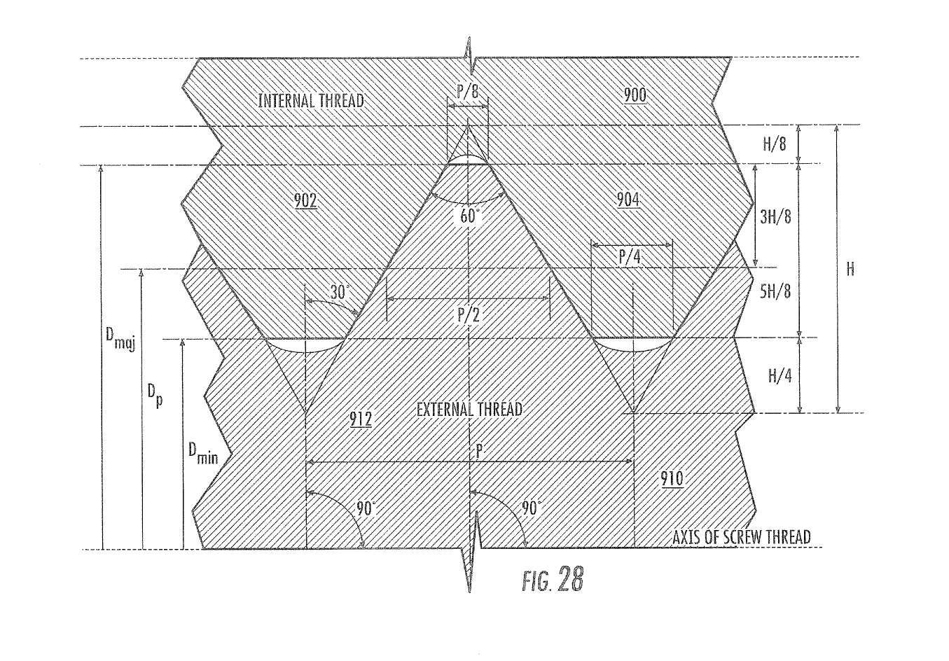

As is discussed below, pursuant to embodiments of the present invention, coaxial “F” connectors are provided which have rotatable nuts that are designed to exhibit increased drag and mechanical resistance. Before describing these nuts it is helpful to define certain properties of threads for nuts and bolts that comply with the Unified Thread Standard or “UTS”, which is a standard that defines the profile for screw threads that are commonly used in the United States and Canada. In particular, FIG. 28 is a cross-sectional diagram of a portion of a nut 900 that is mated with a bolt 910 that illustrates the thread profiles for a UTS-compliant nut and the bolt.

As shown in FIG. 28, the threads for both the nut 900 (i.e., the “internal” thread) and the bolt 910 (i.e., the “external thread”) are symmetric V-shaped threads. As shown in FIG. 28, the centerline of each thread bisects the longitudinal axis of the bolt 910 at an angle of 90 degrees (herein the “thread angle”). In the plane of the thread axis, the flanks of the V on each thread form a 60 degree angle. The outermost ⅛^{th} of each external thread (i.e., the threads on the bolt 910) are cut off so that the peak of each thread on the bolt 910 has a flat profile. The innermost ¼ of each internal thread (i.e., the threads on the nut 900) are cut off so that the peak of each thread on the nut 900 similarly has a flat profile.

The threads are further defined by their major diameter Dₘₐₓ, their minor diameter Dₘᵢₙ and their pitch P (i.e., the distance that a screw advances during a 360 degree rotation). For an external thread (i.e., the threads on the bolt 910), the major diameter Dₘₐₓ and the minor diameter Dₘᵢₙ are maximum dimensions. Thus, for an external thread to be standards compliant, the major diameter Dₘₐₓ and the minor diameter Dₘᵢₙof the threads must be less than or equal to the specified values in the standard. As shown in FIG. 28, an external thread may have a major diameter Dₘₐₓ and/or a minor diameter Dₘᵢₙ that is less than called for by the standard (e.g., the minor diameter of thread 912 has been rounded out so that it is less than the value Dₘᵢₙ that is specified in the UTS standard). For an internal thread to be standards compliant, the major diameter Dₘₐₓ and the minor diameter Dₘᵢₙ of the threads must be greater than or equal to the specified values in the standard. As shown in FIG. 28, an external thread may have a major diameter Dₘₐₓ and/or a minor diameter Dₘᵢₙ that is less than called for by the standard (e.g., the minor diameter of thread 912 has been rounded out so that it is less than the value Dₘᵢₙ that is specified in the UTS standard). The distance Dₘᵢₙ defines the internal diameter of the nut 900.

F-style coaxial connectors are commonly used in homes and other premises to connect televisions and cable modems to wall-mounted female coaxial cable ports. As the television sets and/or cable modems are moved, axial or other forces may be applied to the coaxial cable that can loosen the connection between one or both of the F-style coaxial connectors on either end of the cable and the female coaxial cable ports with which they are mated. By way of example, televisions that are mounted on a swiveled base may be swiveled repeatedly during ordinary use. This rotation can apply axial forces on the coaxial cable that connects to the female coaxial cable port on the television which, over time, can loosen the connection. As the connection is loosened, the cable television signal carried by the coaxial cable may be degraded and/or lost.

Typically, when an F-style coaxial connector is tightened by hand onto a female coaxial cable port, the installer will apply a force of approximately 3-4 inch/lbs. to the rotatable nut on the coaxial connector. Such a force, however, may not be sufficient to prevent the coaxial connector from being loosened when subjected to forces that may be applied during normal operation. In order to prevent such loosening, it has been recommended that a force of 20-40 inches/lb. be applied to an F-style coaxial connector when it is attached to a female coaxial cable port. However, the female coaxial cable ports on televisions, cable modems and other consumer electronic devices may not always be rated to withstand such forces, and thus there is a reluctance to tighten the F-style coaxial connector using forces of 20-40 inches/lb. for fear that an expensive electronic component may be damaged if the female coaxial cable port on the equipment cannot withstand such a force.

Pursuant to embodiments of the present invention, coaxial “F” connectors are provided which have rotatable nuts that are designed to exhibit increased drag and mechanical resistance. As such, once installed on a female coaxial cable port, the F-style coaxial connectors according to embodiments of the present invention will resist loosening, and therefore may provide a more robust mechanical connection and/or improved electrical performance over time. The rotatable nuts on the F-style coaxial connectors disclosed herein may use one or more of a variety of different retention mechanisms such as tipped threads, pipe threads, internal bushings, chamfered internal diameters and/or dimples to provide the increased drag and mechanical resistance.

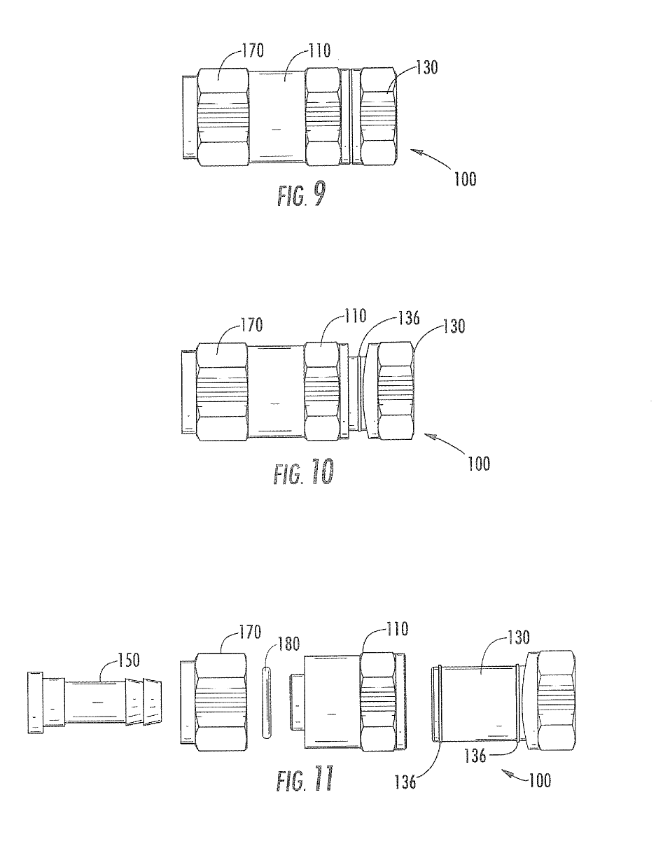

FIG. 7 is a perspective view of an F-style coaxial connector 100 on which the rotatable nuts according to certain embodiments of the present invention may be used. FIG. 8 is an exploded perspective view of the F-style coaxial connector 100 with certain components thereof shown in a cut-away view. FIGS. 9-11 are side views of the connector 100 in various states of assembly.

As shown in FIGS. 7-11, the connector 100 includes a tubular connector body 110, a compression sleeve 130, an inner contact post 150 and an internally threaded rotatable nut 170. As shown in FIG. 8, the connector body 110 includes a top end 112 and a bottom end 114, and the compression sleeve 130 likewise includes a top end 132 and a bottom end 134. When inserted into the connector body 110, the compression sleeve 130 circumferentially surrounds an upper portion 152 of the inner contact post 150.

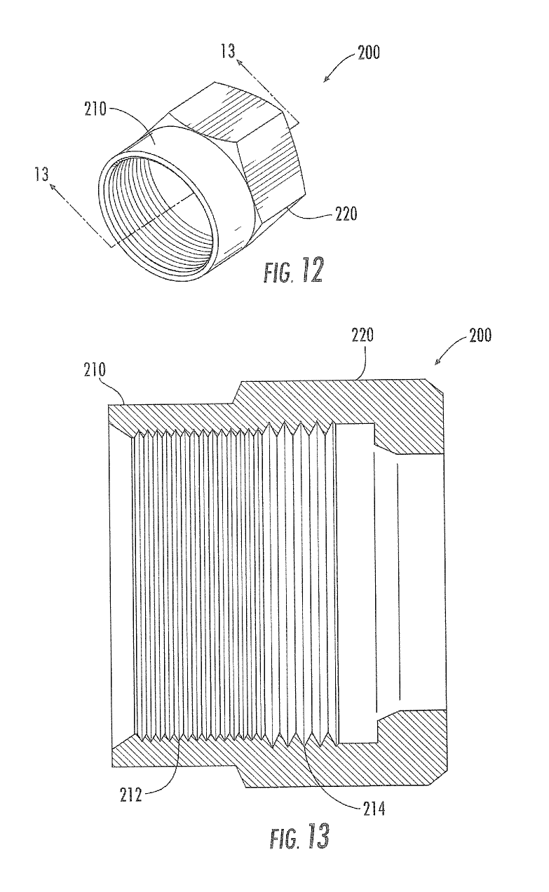

FIGS. 9-11 illustrate the connector 100 in various states of assembly. In FIGS. 9-11, the cable 10 has been omitted in order to simplify the drawings. FIG. 9 illustrates how the connector appears once the compression sleeve 130 has been inserted into the connector body 110 in order to lock the cable 10 into place. FIG. 10 illustrates how the connector appears before it is terminated onto a cable. The connector body 110 may include grooves or recesses (not visible in FIGS. 9-11) and the compression sleeve 130 may include detents or other raised surfaces (one such detent 136 is visible in FIGS. 10-11) that mate with the grooves in order to hold the compression sleeve 130 in place within the connector body 110. As a result, the connector 100 may readily be maintained as a single piece unit until such time as a cable 10 is to be attached to the connector 100. The mating raised surfaces/recesses may be designed to only apply a small retention force so that the compression sleeve 130 may be readily moved into the position of FIG. 9 when terminating a cable 10 with the connector 100. FIG. 11 is an exploded side view of the connector 100 which more clearly shows the alignment of the inner contact post 150, the internally threaded nut 170, the connector body 110 and the compression sleeve 130. As is also shown in FIG. 11, an optional O-ring or other type of seal 180 may be provided to enhance the moisture seal.

In order to terminate the connector 100 onto the end of a coaxial cable 10, the cable 10 is first prepared as shown in FIG. 2 by cutting away and removing end portions of the dielectric 14, the tape 16, the electrical shielding wires 20, the electrical shielding tape 22 and the cable jacket 24 so that the end portion of the central conductor 12 is fully exposed. An additional end portion of the cable jacket 24 is then removed, and the end portions of the electrical shielding wires/tape 20/22 are flared or folded back in whole or in part over the remainder of the cable 10. The core 18 of the cable 10 is then axially inserted through the compression sleeve 130 and into the inner diameter of the inner contact post 150, while the electrical shielding wires/tape 20/22 and the cable jacket 24 are inserted through the compression sleeve 130 and over the outside surface of the inner contact post 150. The exposed length of the central conductor 12 core is sufficient such that it will extend all the way through the connector 100 and extend into the internally threaded nut 170 of the connector 100 as the male contact protrusion of the connector.

During this insertion process, the connector 100 may be in the assembly state shown in FIG. 10. Once the cable 10 is received within the connector 100, a compression tool may be used to fully insert the compression sleeve 130 into the connector body 110 so that the connector assumes the position of FIG. 9. The inner diameter (not visible in FIGS. 7-11) of the upper end 132 of the compression sleeve 130 may have a smaller radius than the inner diameter of the lower end 134 of the compression sleeve 130. A ramped transition section may connect the inner radii of the upper and lower ends of the compression sleeve 130. As the compression sleeve 130 is driven into the connector body 110, the gap between the inside diameter of the compression sleeve 130 and the jacket 24 of the cable 10 is reduced and ultimately disappears as the upper end 132 of the compression sleeve (with the reduced circumference) is forced over the cable jacket 24. Thus, once the compression sleeve 130 is fully inserted and seated within the connector body 110, the compression sleeve 130 imparts a 360-degree compression force on the jacket 24.

As noted above, pursuant to embodiments of the present invention, rotatable nuts for F-style coaxial connectors are provided that exhibit increased drag and mechanical resistance once the connector is mated with a female coaxial cable port. A number of different embodiments of such nuts are described below with reference to FIGS. 12-24. Any of these nuts may be used with the connector 100 of FIGS. 7-11 to provide an F-style coaxial connector according to embodiments of the present invention.

FIGS. 12 and 13 are a perspective view and a cross sectional view, respectively, of one such internally threaded nut 200 that includes “tipped” threads that provide such increased drag and mechanical resistance. The nut 200 could be used, for example, as the nut 170 in the connector 100 of FIGS. 7-11. As shown in FIG. 12, the nut 200 includes a relatively narrow first end 210 and a relatively wider second end 220 that has a hexagonal-shaped exterior that may receive the end of a wrench. As shown in FIG. 13, the internal surface of the first end 210 is internally threaded, having a first set of threads 212 and a second set of threads 214. The first set of threads 212 may be standard threads, while the second set of threads 214 may be “tipped” threads. In the depicted embodiment, the tipped threads 214 are the last four threads that are closest to the relatively wider second end 220 of the nut 200.

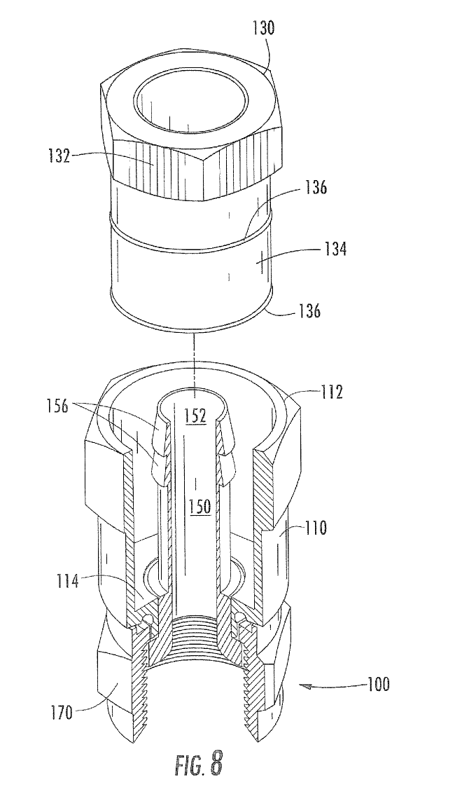

Herein, the term “tipped” threads refers to nut threads that have (1) a thread angle that is offset from 90 degrees or (2) major diameters and/or minor diameters that are less than the values called for by the UTS standards. By way of example, the thread angle can be offset from 90 degrees by angling the internal threads 902, 904 in FIG. 28 slightly to either the right or to the left. The minor diameter of an internal thread (e.g., thread 902 in FIG. 28) may be decreased to provide a tipped thread by, for example, rounding or angling the top of the thread to extend into the interior of the nut past the distance Dₘᵢₙ specified in the standard and/or by extending the thread farther into the interior of the nut (while keeping a flat profile at the peak of the thread). The major diameter of an internal thread (e.g., thread 902 in FIG. 28) may be decreased to provide a tipped thread by, for example, filling in the valley of the thread (either uniformly or not) so that the distance Dₘₐₓ is less than the value specified in the UTS standard. By changing the thread angle and/or major or minor diameter of the threads, the interface between the threading on the nut 200 and the threads on a UTS-compliant mating female coaxial connector port (e.g., port 40 of FIG. 6) can be slightly mismatched, thereby increasing the force required to thread the nut 200 onto the mating female coaxial connector port 40 and to unthread the nut 200 from such a mating female coaxial connector port 40. As will be discussed in more detail below, pursuant to embodiments of the present invention coaxial connectors are provided that have rotatable nuts that include both a first set of threads that has UTS standard compliant threads and a second set of threads that has threads that are not compliant with the UTS standard that provide increased drag or resistance.

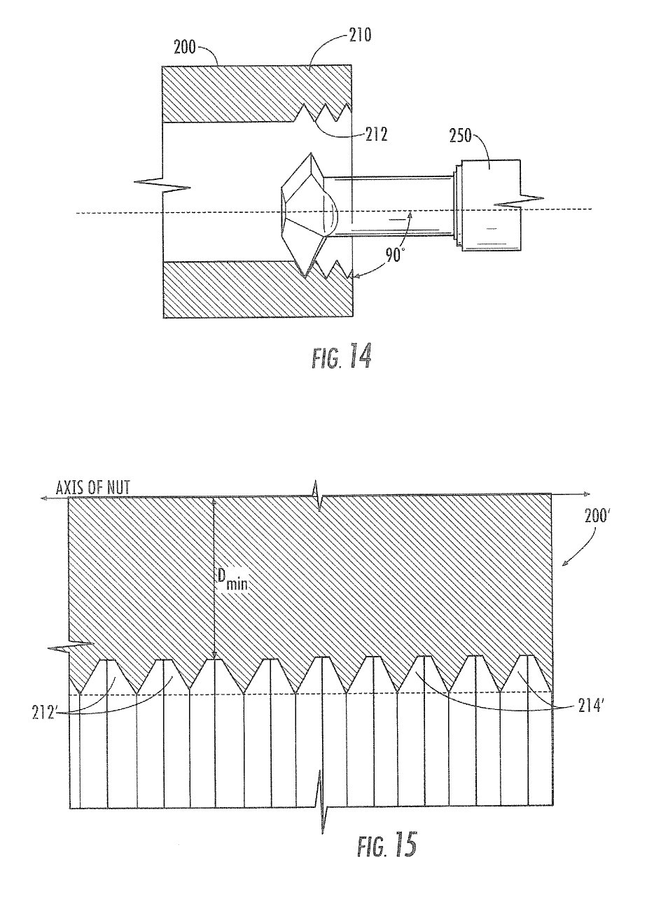

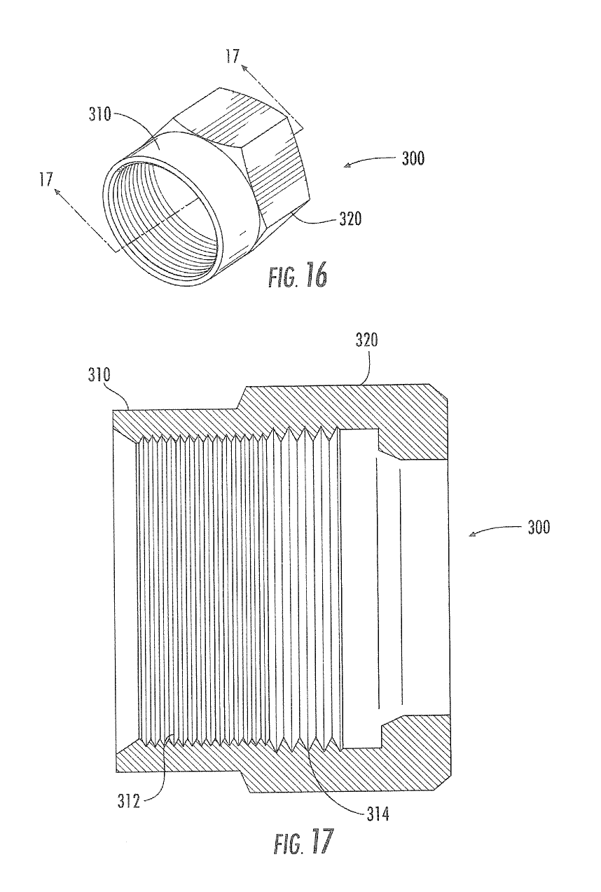

FIG. 14 is a schematic diagram showing how tipped threads having a thread angle that varies from 90 degrees may be formed. As shown in FIG. 14, a cutting tool 250 may be used to cut the threads 212, 214 in the internal diameter of the first end 210 of nut 200. To cut the threads 212, the longitudinal axis of the cutting tool 250 is maintained parallel to the longitudinal axis of the nut 200 (i.e., at an angle of 90 degrees with respect to a lateral cross-section of the nut 200). In contrast, with the tipped threads 214 (not shown in FIG. 14), the longitudinal axis of the cutting tool 250 is rotated to, for example, an angle of 85 degrees with respect to a lateral cross-section of the nut 200 to provide threads having a thread angle that is offset from 90 degrees. It will be appreciated that the cutting tool may be rotated in either direction from 90 degrees (e.g., to an angle of 95 degrees instead of 85 degrees), and that the greater the offset from 90 degrees, the higher the degree of increase in the drag and mechanical resistance. In some embodiments, the thread angle of the threads 214 are offset from 90 degrees by between 0.5 and 2.5 degrees. It will be appreciated that tipped threads may be formed in other ways than shown in FIG. 14.

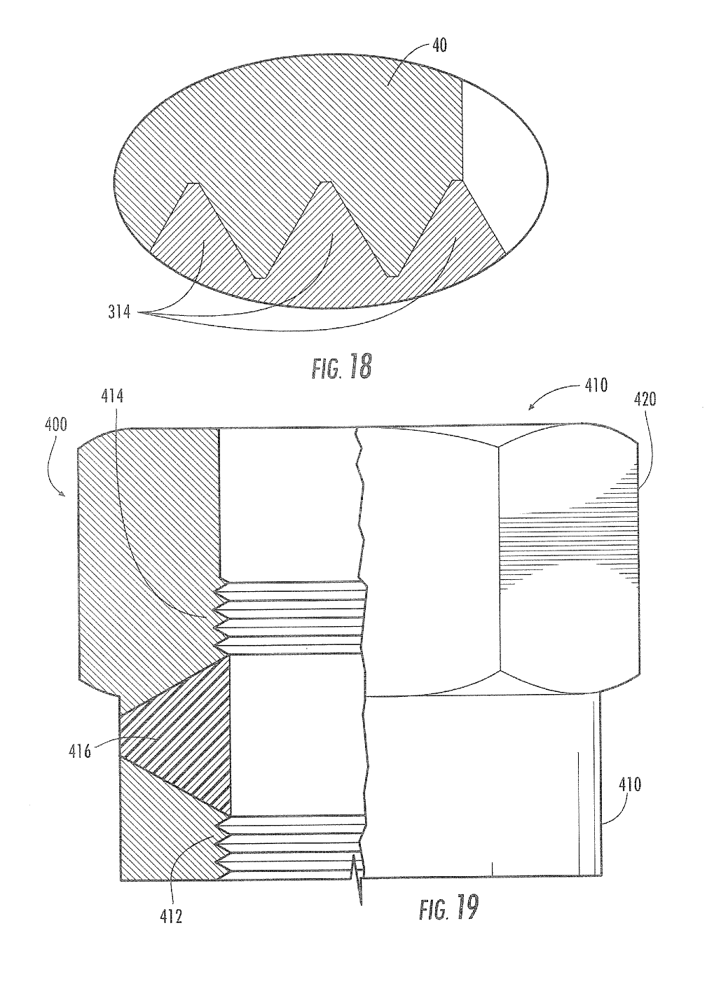

FIG. 15 is an enlarged cross-sectional view of a small portion of a nut 200′ in which the tipped threads comprise tipped threads 214′ that have a minimum diameter that is less than the specified minimum diameter value Dₘᵢₙ set forth in the UTS standards (i.e., the peaks of the threads 214′ extend further into the interior of the nut than do the peaks of the UTS-compliant threads 212° that are provided in a different part of the nut 200′). The nut 200′ can have an external appearance that is essentially identical to the external appearance of nut 200 (see FIG. 12), and hence a full drawing of the nut 200′ is not provided. As shown in FIG. 15, the peaks of the threads 214′ extend about 5% further into the interior of the nut 200′ than do the peaks of the normal threads 212′; the valleys of the threads 214′ extend the same distance into the interior of the nut 200′ as do the valleys of the UTS-compliant threads 212′ (i.e., the major diameter of each of the threads 214′ is UTS-compliant).

When the nut 200 or the nut 200′ is mated with the female coaxial connector port 40, the UTS-compliant threads 212 are designed to mate with the external threads 42 on the port 40. However, as the nut 200 or 200′ is further tightened onto the port 40, the leading threads 42 of the port 40 contact the tipped threads 214 or 214°. Because these tipped threads 214, 214′ either have a thread angle that is offset from 90 degrees or have non-compliant major or minor thread diameters, the external threads 42 on port 40 will not mate perfectly with the threads 214, 214′, thereby providing increased drag and mechanical resistance.

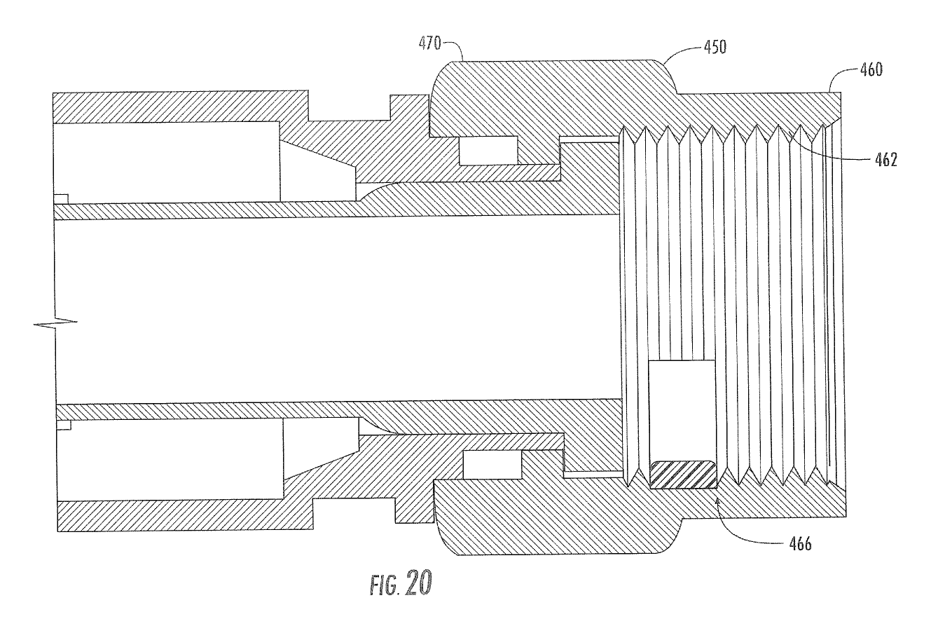

FIG. 16 is a perspective view of a nut 300 for an F-style coaxial connector according to further embodiments of the present invention. The nut 300 includes several pipe threads that provide increased drag and mechanical resistance. FIG. 17 is a cross-sectional view of the nut 300. The nut 300 could be used, for example, as the nut 170 in the connector 100 of FIGS. 7-11. As shown in FIG. 16, the nut 300 includes a relatively narrow first end 310 and a relatively wider second end 320 that has a hexagonal-shaped exterior that may receive the end of a wrench. As shown in FIG. 17, the internal surface of the nut 300 has a first set of threads 312 that extend throughout the first end 310 of the nut and part way through the second end 320 of the nut 300. The internal surface of the second end 320 of the nut 300 also includes a second set of threads 314. The first set of threads 312 may be standard threads, while the second set of threads 314 may be pipe threads. In the depicted embodiment, the pipe threads 314 are the last four threads at the bottom of the end 320. The pipe threads may be non-UTS standard compliant threads.

As is known to those of skill in the art, pipe threads are tapered threads that are used to join pipes and other fittings. In some embodiments, pipe threads may have a larger leading edge and/or a much sharper crown. When a torque is applied to pipe threads, the flanks of the tapered threads compress against each other and displace a small amount of material to form a seal, in contrast to parallel/straight threads which hold two pieces together without forming such a seal. FIG. 18 is an enlarged cross-sectional view of a small portion of the pipe threads 314 of the nut 300 of FIGS. 16-17 after the nut 300 has been mated with a female coaxial connector port 40. As shown in FIG. 18, when the nut 300 is screwed onto the female coaxial connector port 40, the tops of the peaks of the pipe threads 314 are displaced, as are the peaks of the mating threads on the female coaxial connector port 40. The displacement of this material may form a sealed area, and may also provide additional drag and mechanical resistance that resists any forces that would otherwise tend to loosen the connection.

Pursuant to still further embodiments of the present invention, nuts for F-style coaxial connectors are provided that include bushings such as a nylon or plastic bushing within their internally threaded section. FIG, 19 is a partially cutaway side view of one such nut 400. FIG. 20 is a side cross-sectional view of an F-style coaxial connector that includes a nut 450 that has a small bushing that is disposed within the internal threads of the nut.

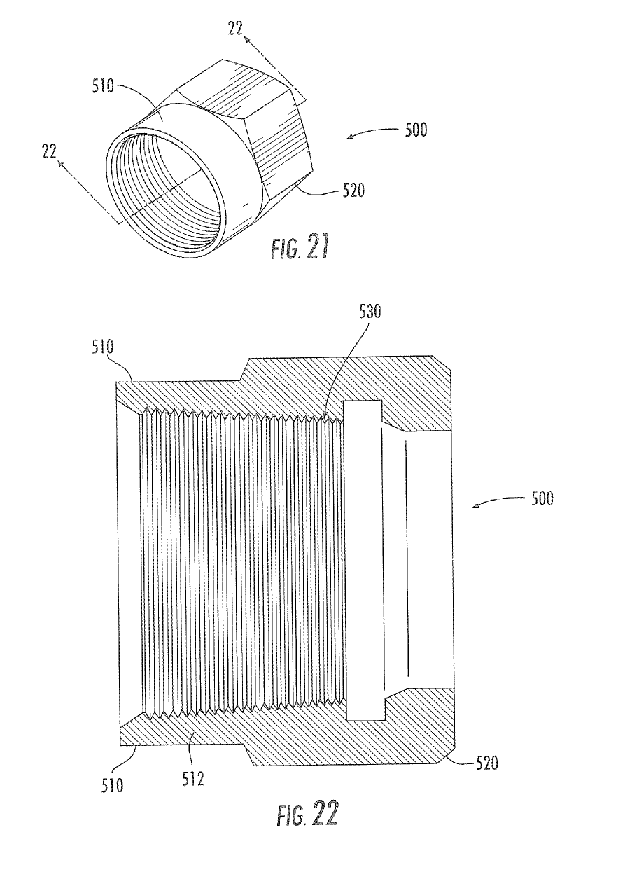

As shown in FIG. 19, the nut 400 includes a relatively narrow first end 410 and a relatively wider second end 420 that has a hexagonal-shaped exterior that may receive the end of a wrench. The internal surface of the first end 410 is internally threaded with a first set of threads 412 and part of the internal surface of the second end 420 is internally threaded with a second set of threads 414. The first set of threads 412 and the second set of threads 414 are spaced apart, and a bushing 416 such as, for example, a nylon or plastic bushing, is disposed between the first and second sets of threads 412, 414. Typically, the bushing 416 will not be threaded at the time it is manufactured, although threads are cut into the bushing when the nut 400 is screwed onto a female coaxial cable port such as port 40 of FIG. 6. When the nut 400 is mated with the female coaxial cable port 40, a small amount of the bushing material is displaced, and this displaced material forms a seal that tends to resist further rotation of the nut 400 (in either direction).

As shown in FIG. 20, the nut 450 likewise includes a relatively narrow first end 460 and a relatively wider second end 470 that has a hexagonal-shaped exterior that may receive the end of a wrench. The internal surface of the first end 460 and part of the internal surface of the second end 470 are internally threaded with a set of threads 462. A small section of the threads 462 is replaced with a bushing 466 such as, for example, a nylon or plastic bushing. Typically, the bushing 466 will not be threaded at the time it is manufactured, although threads are cut into the bushing 466 when the nut 450 is screwed onto a female coaxial cable port such as port 40 of FIG. 6. When the nut 450 is mated with such a female coaxial cable port 40, a small amount of the bushing material is displaced, and this displaced material forms a seal that tends to resist further rotation of the nut 450 (in either direction).

In some embodiments (such as the nut 400 of FIG. 19), the bushing may be an annular bushing 416 that circumscribes the interior diameter of the nut 400. As shown in FIG. 20, in other embodiments, the bushing (e.g., bushing 466) may only circumscribe a portion of the interior diameter of the nut. Typically, the bushing will be sized to replace all or part of 2-4 threads of the nut, although other sized bushings may also be used. Typically, threads will be provided on both sides of the bushing along the longitudinal axis of the nut, although in some embodiments, the bushing may replace all or part of the last threads of the nut such that threads are only provided on one side of the bushing.

As shown in FIG. 6, the distal end 44 of a female coaxial cable port 40 that is received within an F-style coaxial connector has a flat surface that mates with the flat bottom surface of the inner contact post of the connector, which acts as a ground plane. Thus, in order to obtain a good ground connection between the female coaxial cable port 40 and an F-style coaxial connector, the nut on the F-style coaxial connector must be fully screwed onto the female coaxial cable port 40. Typically, the female coaxial connector port 40 is not fully threaded to its distal end 44. Consequently, in some embodiments of the present invention, the nuts 400, 450 are designed so that their respective bushings 416, 466 will be offset by a small distance from the bottom surface of the inner contact post when an F-style coaxial connector that includes the nut 400 or 450 is threaded onto the female coaxial cable port 40. As a result, when a user threads the F-style coaxial connector onto a mating female coaxial connector port 40, the user only encounters the increased resistance caused by the bushing 416 or 466 at about the same point that the distal end 44 of the mating female coaxial connector port 40 comes into contact with the ground plane. Thus, by positioning the bushing 416 or 466 in this location, it is possible to increase the probability that a good ground connection is obtained.

FIG. 21 is a perspective view of a nut 500 for an F-style coaxial connector according to further embodiments of the present invention. The nut 500 has an internal diameter that is cut with a slight chamfer to provide increased drag and mechanical resistance when threading the nut 500 onto or off of a mating female coaxial connector port 40. FIG. 22 is a cross-sectional view of the nut 500 that illustrates the slight chamfer 530 in the internal diameter of the nut. As shown in FIG. 22, the nut 500 includes a relatively narrow first end 510 and a relatively wider second end 520 that has a hexagonal-shaped exterior that may receive the end of a wrench. The internal surface of the first end 510 and part of the internal diameter of the second end 520 are internally threaded with threads 512. As can be seen in FIG. 22, the internal diameter of the nut is cut with a slight chamfer 530 so that the internal diameter decreases with increasing penetration into the nut 500.

While the nut 500 includes a chamfer of about two percent (i.e., the internal diameter varies by a total of two percent over the chamfered portion of the nut), in other embodiments the chamfer can be from, for example, about one percent to about three percent. The internal diameter of the nut 500 is designed so that the threads 42 on the distal end 44 of a mating female coaxial connector port 40 will start to cut the inner most threads 512 of the nut 500 when the nut 500 is threaded onto the mating female coaxial connector port 40. As the threads 512 are cut, material is displaced and hence the chamfer 530 helps resist easy rotation once the nut 500 is mated with the female coaxial connector port 40. While in FIG. 22 the chamfer 530 is applied over the entire threaded section of the nut 500, it will be appreciated that, in other embodiments, the chamfer 530 may be applied only over a portion of the threaded section of the nut 500.

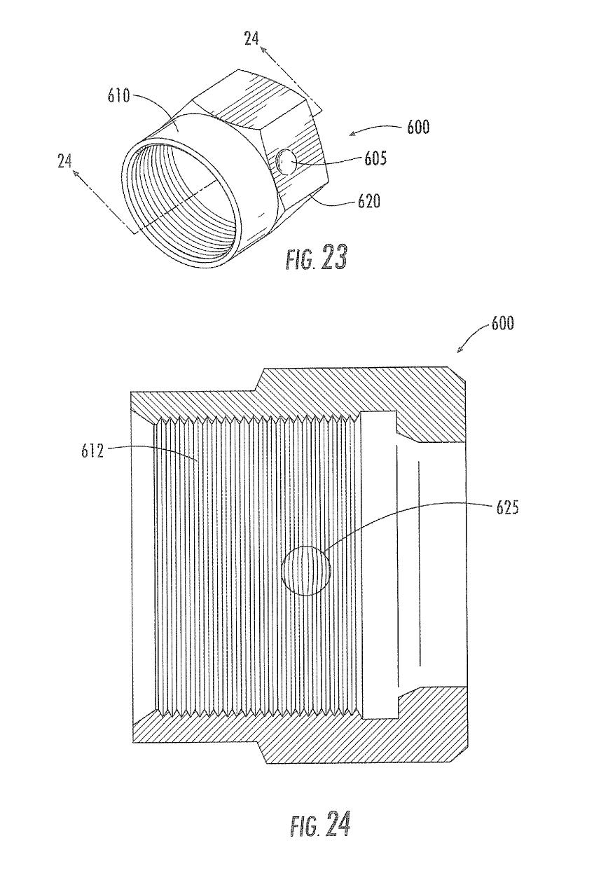

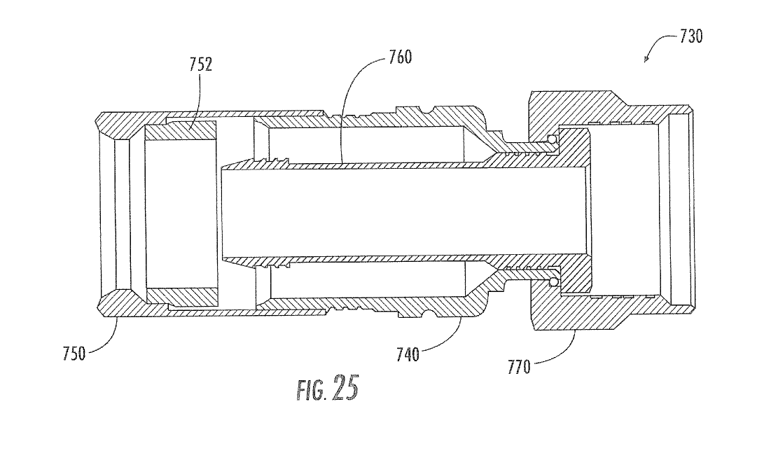

FIG. 23 is a perspective view of a nut 600 for an F-style coaxial connector according to still further embodiments of the present invention. FIG. 24 is a cross-sectional view of the nut 600 of FIG. 23 taken along the line 24-24 in FIG. 23. As shown in FIG. 23, the exterior of the nut 600 is very similar to the nut 500 depicted in FIG. 21. However, the nut 600 is a “dimpled” nut in that during manufacture the external surface of the nut 600 is impacted one or more times with a hard object to form one or more respective dimples 605 in the exterior surface of the nut 600. These dimples 605 may be positioned directly opposite some of the bottom few threads 612 of the nut 600. The external force that creates each dimple 605 drives some of the material of the nut 600 inward, creating a defect 625 in the threads 612 opposite the dimple 605. This defect 625 provides increased drag and mechanical resistance when threading the nut 600 onto or off of a mating female coaxial connector port 40.

The nuts according to embodiments of the present invention may be formed using a variety of materials. Typically, however, the nuts will be formed of bronze or of a material that includes bronze. As is known to those of skill in the art, bronze is a relatively soft metal, and hence the bronze may be deformed, cut or the like when the nuts according to embodiments of the present invention are threaded onto female coaxial connector ports made of a harder metal such as steel. This cutting or deformation of the metal may help facilitate providing the increased drag and/or mechanical resistance provided by nuts according to embodiments of the present invention.

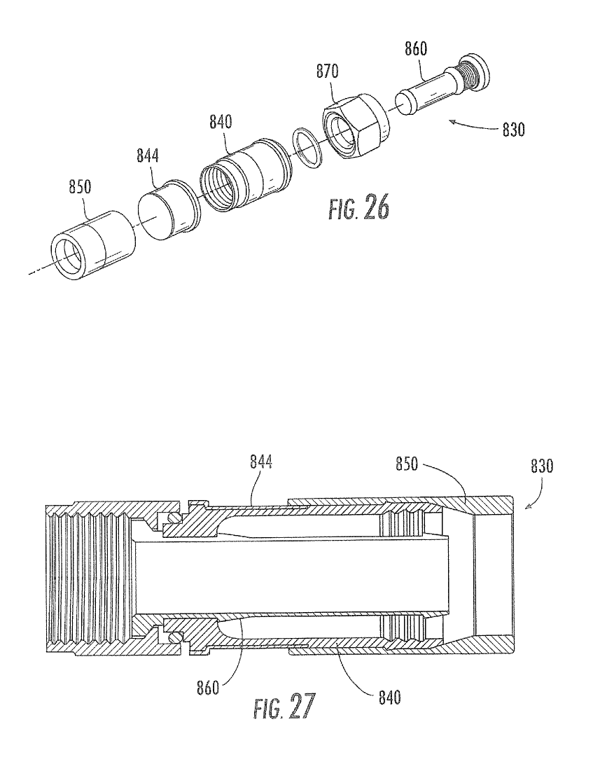

It will be appreciated that the internally threaded nuts according to embodiments of the present invention, such as nuts 200, 200′, 300, 400, 450, 500 and 600 discussed above, may be used on any F-style coaxial connector, and that the invention is not limited to the particular F-style coaxial connector depicted in FIGS. 7-11. By way of example, FIG. 25 illustrates a compression style back-fitting coaxial “F” connector 730 that has a compression sleeve 750 that fits over the outside surface of the connector body 740. The compression sleeve 750 includes an annular internal element 752 that is designed to fit between the contact post 760 and the inside surface of the connector body 740 when the compression sleeve is inserted axially into its seated position within the connector body 740 so as to directly engage the shielding wires and/or jacket of a cable and lock the cable in place within the connector. The nut 770 on connector 730 may be any of the nuts according to embodiments of the present invention. Likewise, FIGS. 26-27 illustrate yet another F-style coaxial connector 830 which may include any of the nuts according to embodiments of the present invention that are described above. The connector 830 once again includes a tubular connector body 840, a compression sleeve 850, an inner contact post 860 and an internally threaded nut 870. The connector 830 further includes a reinforcing shield 844 that fits over a portion of the connector body 840. The compression sleeve 850 again fits over the outside diameter of the connector body 840. A compression tool is used to force the compression sleeve 850 over the connector body 840, and in the process the connector body 840 deforms inwardly to assert a compression/retention force on the jacket and electrical shielding wires/tape of a coaxial cable that is inserted into and over the inner contact post 860.

As discussed above with respect to FIGS. 19 and 20, the nuts 400, 450 may be designed so that their respective bushings 416, 466 are offset by a small distance from the bottom surface of the inner contact post when an F-style coaxial connector that includes the nut 400 or 450 is threaded onto the female coaxial cable port 40 so that the increased resistance that is provided by these bushings 416, 466 only starts to occur at about the same point that the distal end 44 of a mating female coaxial connector port 40 comes into contact with the ground plane of the nut. It will be appreciated that the location of the tipped threads 214, 214′ of nuts 200, 200′, respectively, the location of the pipe threads 314 of nut 300, the location of the threads having a decreased internal diameter of nut 500 and/or the location of the dimple 625 in the threads of nut 600 may likewise be positioned so that the increased resistance that is provided by these features only starts to occur at about the same point that the distal end 44 of a mating female coaxial connector port 40 comes into contact with the ground plane of the nut.

It will be appreciated that many modifications may be made to the exemplary embodiments of the present invention described above without departing from the scope of the present invention.

In the drawings and specification, there have been disclosed typical embodiments of the invention and, although specific terms are employed, they are used in a generic and descriptive sense only and not for purposes of limitation, the scope of the invention being set forth in the following claims.

1. A coaxial connector, comprising:
a connector body;
an inner contact post that is at least partly within the connector body;
a compression element that is configured to impart a generally circumferential compressive force to secure one or more elements of a coaxial cable between the connector body and the inner contact post when the compression element is in a seated position; and
an internally threaded rotatable nut having a first set of threads and a second set of threads that is immediately adjacent to the first set of threads, the rotatable nut being configured for attachment to the connector body,
wherein threads of the second set of threads are configured to provide increased drag and mechanical resistance as compared to threads of the first set of threads when the rotatable nut is threaded onto a female coaxial cable port.

2. The coaxial connector of claim 1, wherein the second set of threads comprises at least some of the four threads that are located closest to the inner contact post.

3. The coaxial connector of claim 2, wherein the second set of threads comprise a plurality of tipped threads that have a thread angle that is offset from 90 degrees.

4. The coaxial connector of claim 3, wherein the thread angle of the tipped threads is offset from 90 degrees by between about 2 degrees and about 10 degrees.

5. The coaxial connector of claim 2, wherein the second set of threads comprise a plurality of tipped threads in which the major diameter and/or the minor diameter of the threads are decreased relative to the threads of the first set of threads so as to provide increased drag and mechanical resistance when the rotatable nut is threaded onto a female coaxial cable port.

6. The coaxial connector of claim 2, wherein the second set of threads comprise a plurality of pipe threads.

7. The coaxial connector of claim 6, wherein the nut is formed of a material including bronze, and wherein the seal that is created when the nut is threaded onto the female coaxial cable port is a reversible seal that can be reversed via hand rotation of the nut.

8. The coaxial connector of claim 2, wherein the second set of threads comprise threads that include at least one defect.

9. The coaxial connector of claim 8, wherein the at least one defect is formed by applying an external force to the outside surface of the nut opposite the internal threads that forms a dimple in the outside surface of the nut.

10. A coaxial connector, comprising:
a connector body;
an inner contact post that is at least partly within the connector body;
a compression element that is configured to impart a generally circumferential compressive force to secure one or more elements of a coaxial cable between the connector body and the inner contact post when the compression element is in a seated position; and
a rotatable nut having a plurality of internal threads that is attached to the connector body,
wherein an internal diameter of the threaded portion of the nut varies along the axial direction.

11. The coaxial connector of claim 10, wherein the internal diameter is only varied over a subset of the threaded portion of the nut.

12. The coaxial connector of claim 11, wherein the internal diameter is varied with respect to at least some of the four threads of the nut that are located closest to the contact post.

13. The coaxial connector of claim 12, wherein the internal diameter varies by between about 1% and about 3%.

14. A coaxial connector, comprising:
a connector body;
an inner contact post that is at least partly within the connector body;
a compression element that is configured to impart a generally circumferential compressive force to secure one or more elements of a coaxial cable between the connector body and the inner contact post when the compression element is in a seated position;
a rotatable nut that is attached to the connector body, the nut having a threaded region that includes a plurality of internal threads; and
a bushing mounted within the threaded region of the nut.

15. The coaxial connector of claim 14, wherein the bushing is located between a first subset of the plurality of internal threads and a second subset of the plurality of internal threads.

16. The coaxial connector of claim 15, wherein the bushing comprises an annular bushing.

17. The coaxial connector of claim 15, wherein the bushing comprises a plug that extends less than 90 degrees around the internal diameter of the nut.

18. The coaxial connector of claim 15, wherein the bushing is positioned such that when the nut is threaded onto a female coaxial cable port, a leading thread of the female coaxial cable port that is closest to a distal end of the female coaxial cable port will come into contact with the bushing within between one and three full rotations of the nut before the distal end of the female coaxial cable port contacts the connector body.

19. The coaxial connector of claim 14, wherein no more than four threads are interposed between a first surface of the bushing that is closest to the contact post and an end of the nut that is closest to the contact post.

20. The coaxial connector of claim 14, wherein the bushing comprises a nylon or plastic bushing.

21. The coaxial connector of claim 1, wherein the threads of the first set of threads comply with the UTS standard and wherein the threads of the second set of threads do not comply with the UTS standard.
